(19) United States
(12) Patent Application Publication
(10) Pub. No.: US 2019/0098361 A1
(43) Pub. Date: Mar. 28, 2019

(54) Module and Method

(71) Applicant: MPHC Ltd. (formerly known as MT DIGITAL MEDIA LIMITED), Jupiter, FL (US)

(72) Inventors: Patrick Michael Sansom, Castaways Beach (GB); Ian James Valentine, London (GB)

(73) Assignee: MPHC Ltd. (formerly known as MT DIGITAL MEDIA LIMITED), Jupiter, FL (US)

(21) Appl. No.: 16/203,753

(22) Filed: Nov. 29, 2018

Related U.S. Application Data
(63) Continuation-in-part of application No. 13/395,641, filed on Sep. 28, 2012.

(51) Int. Cl. H04N 21/462; H04N 21/4402; H04N 21/458; H04N 21/472

(52) U.S. Cl. CPC H04N 21/4622; H04N 21/47202; H04N 21/458; H04N 21/44029

(57) ABSTRACT

The present invention relates to a module and method. A content item options module operative for a content item delivery system, is configured to: determine a change in content type of content items being delivered to a content item receiver apparatus for display on a display apparatus; initiate display of one or more alternative content item identifiers on said display apparatus corresponding to one or more other content items; and respond to selection of a one of said one or more content item identifiers to initiate display of a corresponding other content item on said display apparatus.

### CROSS-REFERENCE TO RELATED APPLICATIONS

This application is a continuation-in-part of U.S. patent application Ser. No. 13/395,641, filed on Sep. 28, 2012, which application is a national stage entry of International Application No. PCT/GB2010/051459, filed Sep. 3, 2010 designating the United States and other countries, the disclosures of which are hereby incorporated by reference in their entirety to provide continuity of disclosure to the extent such disclosures are not inconsistent with the disclosure herein.

### FIELD OF THE INVENTION

The present invention relates to a module and method. In particular, but not exclusively, to a content item receiver module and method for a content item delivery system.

### BACKGROUND

The distribution of media content such as music and video now takes place over various communications channels. For example, music and video may be broadcast over terrestrial VHF and UHF networks to be received by television sets, from satellite to ground stations or domestic satellite receivers and over cable networks. Such broadcast services generally comprise one or more communication channels, each channel comprising a particular carrier frequency onto which is modulated a signal representative of the content to be transmitted over the channel. Content, typically television programmes, films or music shows, are transmitted over a particular channel or channels at particular times in accordance with a programme schedule. In this regard, broadcast services comprise “appointments to view” whereby a viewer has to tune into a channel at the time content of interest to the viewer is transmitted on that channel.

More recently, interactive television has become available whereby a viewer, prompted by a message displayed on the television, may send control signals or messages to the broadcaster or third party associated with the broadcaster and displayed message to initiate certain activity. For example, to initiate selection of a programme to view or receive information about a programme.

Broadcast services are widely available using digital communications techniques. Digital broadcast service providers often provide data to populate a menu or Electronic Programme Guide (EPG) of, for example, a set-top box or television with suitable EPG software, on one of their channels. A typical EPG is based on a grid system and displays programmes and channels in transverse directions. For example, the programmes for a particular channel may be displayed in a horizontal direction with different channels set out in a vertical direction. A viewer may use a remote control having “UP/DOWN” and “LEFT/RIGHT” buttons and use these buttons to move a cursor about the display to highlight programmes. A viewer may select a highlighted programme by actuating a “SELECT” button which tunes the receiver to the particular cannel. Optionally, a viewer may highlight a programme which is to be broadcast in the future and selection of that programme may invoke a “record” or “reminder” option.

Television viewers are generally familiar with EPGs set out in a grid system and navigable using remote control devices having relatively simple buttons such as “UP/DOWN” and “LEFT/RIGHT” buttons and “SELECT” buttons.

Content is also available over computer networks such as the Internet. Content is usually accessed over the Internet using a personal computer such as a desktop or laptop computer. The location of content on a network such as the Internet is defined by a network address known as a Uniform Resource Locator (URL). A particular content item can be addressed and downloaded to the computer addressing the content for later presentation or may be “streamed” whereby the computer presents the content as it is provided over the network. The user interface for a computer is generally a pointing device such as a “mouse”, and computer users are familiar with a user interface which allows for the pointing device to be moved on to an icon, text (such as an Internet “link”) or other graphic displayed on a display and selecting that graphic to invoke a function associated with the graphic, for example accessing content over the Internet.

Many communications networks, including those making up at least a part of the internet, are configured to transmit large amounts of data and these are sometime termed “broadband” networks. For the purpose of this description the term “broadband network” is used refer to a communications network or part thereof which is capable of transmitting content items such as video and music in an acceptable timeframe. Such networks may also support music or video streaming. The data bandwidth capability of a consumer connection to such a network is typically at least 2 MBit/s.

Many computer users have computers which are part of a local area network (LAN), for example in their workplace and increasingly at home in their domestic residence. Users often keep content items on memory storage coupled to their LAN and access content through their computers.

A consequence of users having a plurality of different sources of information and becoming used to being able to choose what they wish to access or view is that users have become impatient when presented with information they do not wish to view, for example advertisements. In the broadcast environment many channels have commercial breaks in their programming. Such commercial breaks may be paid for advertising by companies wishing to promote their products or services, or maybe by the broadcaster themselves promoting upcoming services or programmes. Users may wish to avoid such unwanted viewing, but in live broadcast must either switch channels and hope to go to a channel without a current commercial break or go and do something else. Conversely, broadcasters (on behalf of their advertisers or themselves) wish to retain the viewer through the commercial break.

Also, the type of content in a programme may vary throughout the programme. A user not wishing to view the content when it changes is likely to move away from a particular channel. One example may be a live football program in which the content type changes from showing the football game to studio chat between football “pundits”. In such a scenario the content type has changed from the football game to studio chat and a user may change their viewing from the studio chat to another program. However, a user may wish to return to the particular program when the content type changes back to the live football game or a broadcaster of the live football game may wish to encourage a user back to the live football broadcast.

Aspects and embodiments of the present invention were devised with the foregoing in mind.

Viewed from a first aspect, there is provided a content item options module operative for a content item delivery system, configured to:

determine a change in content type of a content item being delivered to a content item receiver apparatus for display on a display apparatus; initiate display of one or more content item identifiers on said display apparatus corresponding to one or more other content items; and respond to selection of a one of said one or more content item identifiers to initiate display of a corresponding other content item on said display apparatus.

Viewed from a second aspect, there is provided a method of operating data processing apparatus for a content item delivery system, the method comprising:

determining a change in content type of a content item being delivered to a content item receiver apparatus for display on a display apparatus;

initiating display of one or more content item identifiers on the display apparatus corresponding to one or more other content items; and

responding to selection of a one of the one or more content item identifiers to initiate display of a corresponding other content item on the display apparatus.

In accordance with the first and second aspects it is possible to automatically monitor the changes in content of content items being received by a content item receiver apparatus.

The content type of the content item may be monitored.

One or more other content items having content of a similar type to a content type of said content item may be identified. In this way a database of content items of similar content type to the content type of the content item having undergone a change may be created.

Thus, a search for one or ore other content items may be undertaken, for example a search in a content item cache disposed in the content item delivery system for the one or more other content items. Optionally or additionally such a search may be undertaken over a network interface for searching over a broadband communications network for the one or more content items.

Suitably, there is a search for the one or more other content items amongst data identifying content items and content type currently broadcast on channels of a broadcast communications network. In particular, the search for the one or more other content items is from amongst data identifying content items and content type controlled by a same entity controlling said content item. In this way, the entity controlling the content item may ensure that the other content items are also controlled by them thereby retaining a user to their content item output.

The Broadcaster may also offer online “catch-up” TV shows or relevant content when a viewer tunes into a particular channel half way through a particular show. For example; Alternatives could be “Watch this Show from the Beginning”, or “Watch earlier episodes of this Show”, or “Watch the previous episode of the next show”.

In the common case where the user tunes to a channel and selects an alternative, the content item receiver (if it has recording capability) would start a time-shift recording of the current channel to its local storage, allowing a return to the delayed channel content once the alternative substituted content item is finished playing.

This alternative content option may also be used by an operator to offer the viewer different sources of the same or related content, and highlight price or quality comparisons. For example, “to Watch this Film choose 1) in SD from Sky—as part of your Movies Subscription, 2) in HD from Netflix for $3 (progressive download) or 3) Record the 1978 version of this movie tomorrow on Film 4”.

Suitably, a return to the content type of the content item may be determined thereby providing a mechanism for a user to be automatically return to the content item they were watching when the content type returns to the content type prior to the change in content type. This promotes user loyalty to a programme or channel, and enhances retention of a user in viewing a particular programme or channel.

Typically, the return is based on information concerning duration for the change of content type. For example, a fixed break in a live sports event.

Initiating automatic return to live or delayed delivery and display of the content item responsive to determining the return to said content type may be attractive to a user since they do not have to take any action in order to return to the programme or channel that they had been watching. Optionally, a viewer message may be displayed on the display apparatus providing a user actionable option to return to the content item or continue with the display of the corresponding other content item, thereby providing a user with choice as to whether or not to return to the previously viewed content item.

It may be particularly useful to identify further content items having a duration commensurate with the duration between the change in content type and return to the content type since they will naturally fill the gap between content type. However, it may also be possible to truncate the further content items so that they have a duration commensurate with the duration between the changed content type and return to the content type.

One or more embodiments of the present invention are described further hereinafter, by way of example only, with reference to the accompanying drawing in which:

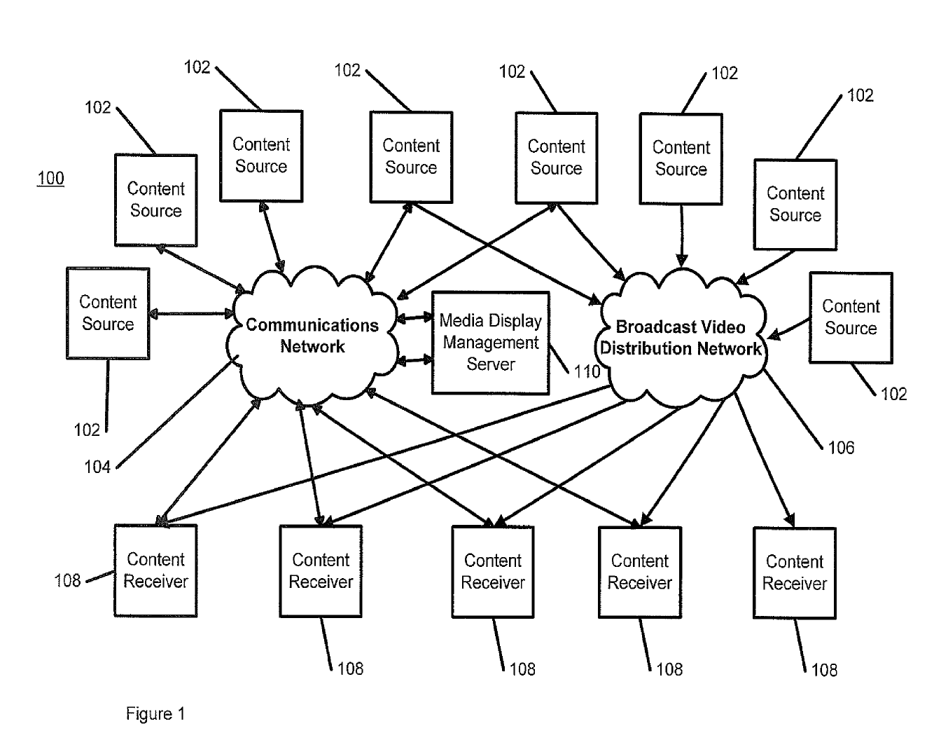

FIG. 1 schematically illustrates components and communication links of a system for providing access to content from a plurality of sources, including broadcast and broadband communications in accordance with an embodiment of the invention;

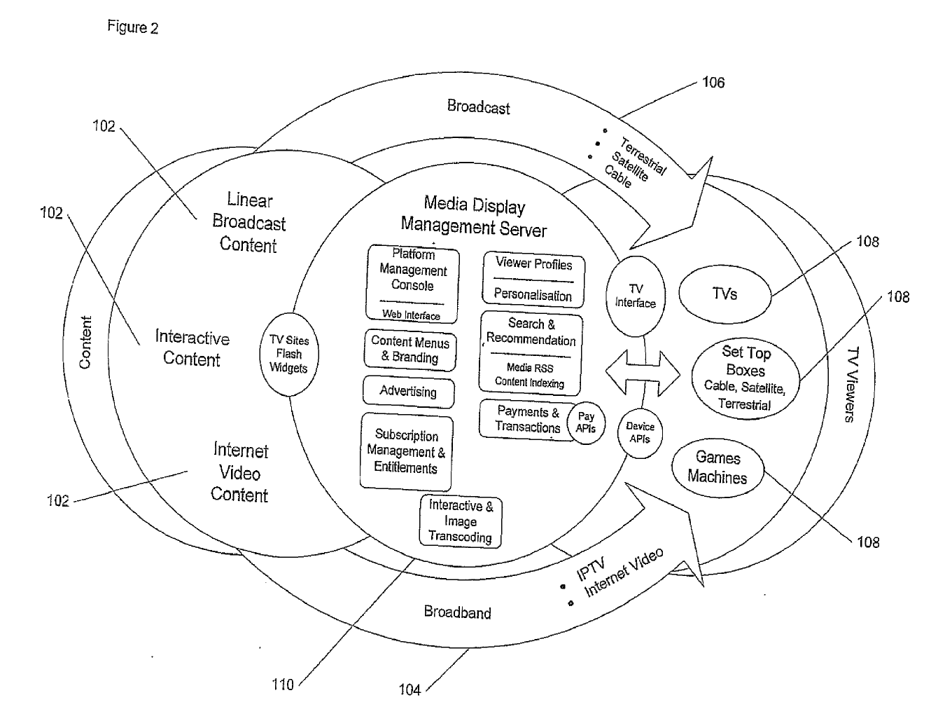

FIG. 2 schematically illustrates the system of FIG. 1 in more detail;

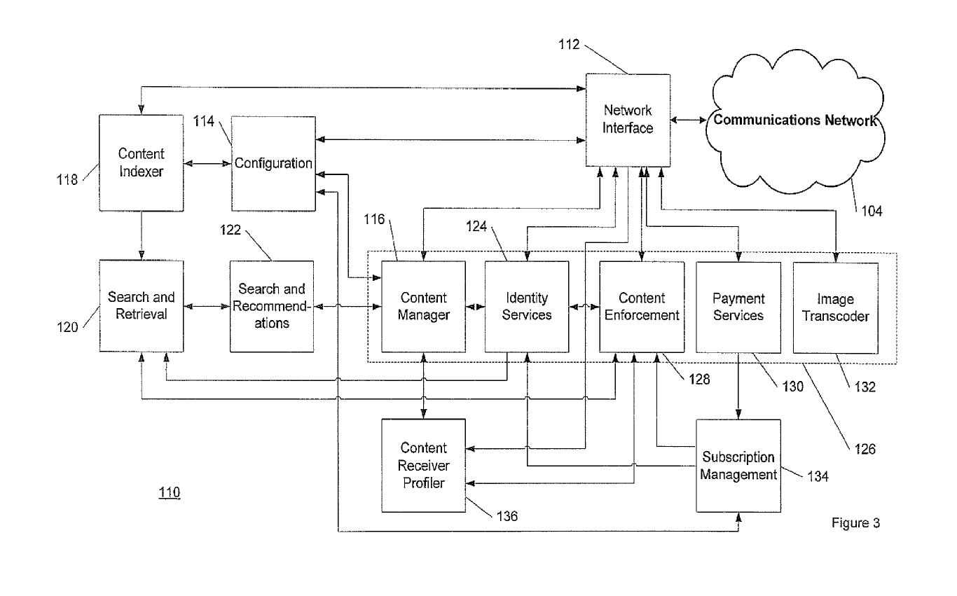

FIG. 3 schematically illustrates a media display management server and components thereof in accordance with an embodiment of the invention;

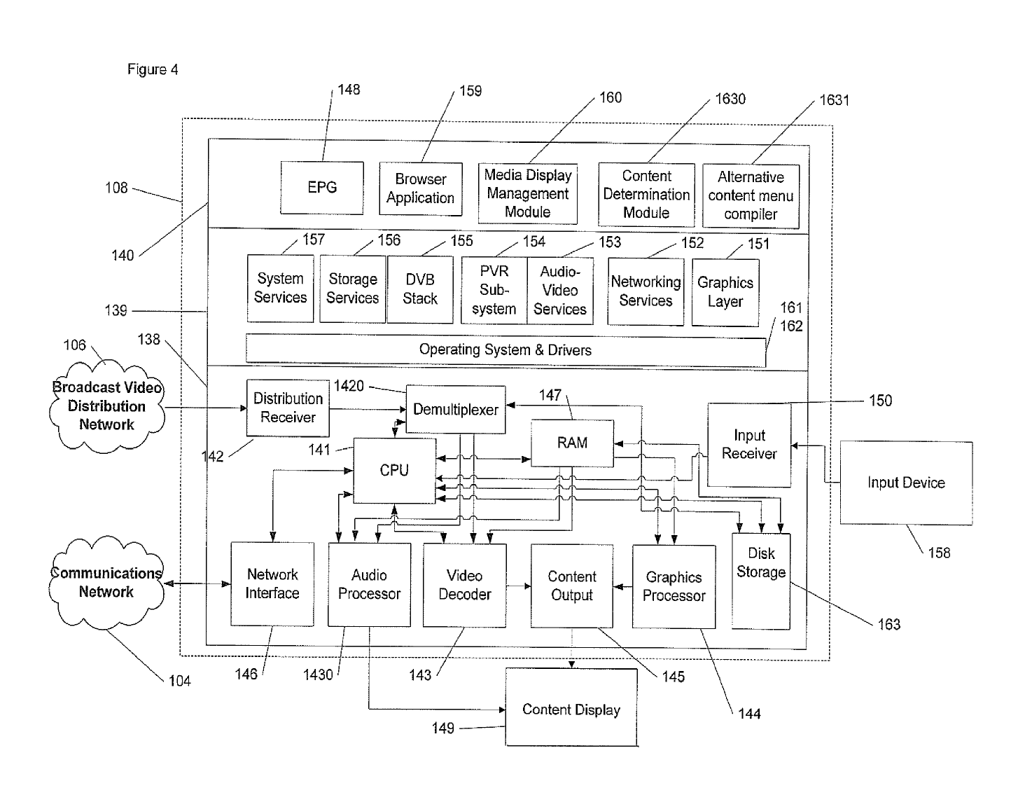

FIG. 4 schematically illustrates a content receiver and components thereof in accordance with an embodiment of the invention;

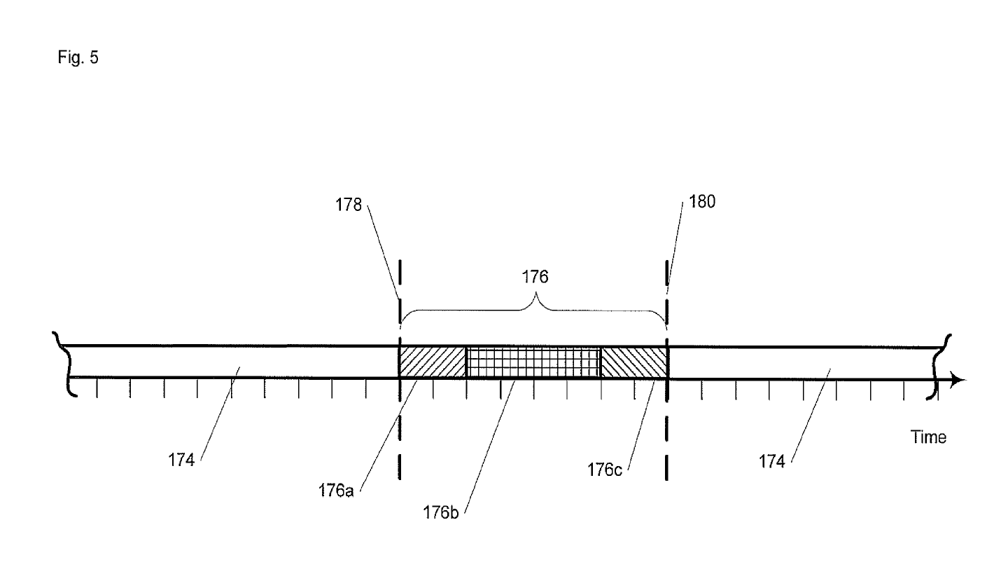

FIG. 5 schematically illustrates a conventional broadcast transport stream;

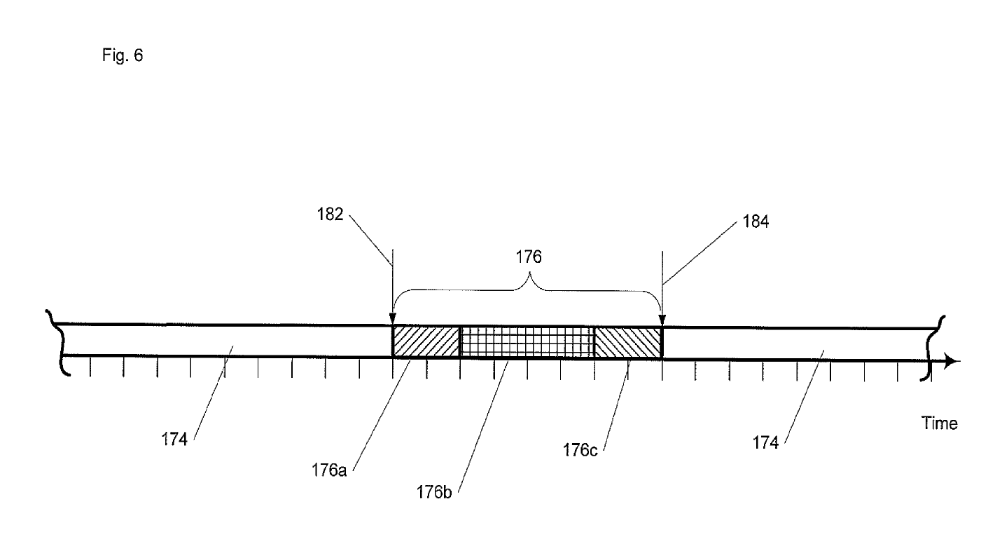

FIG. 6 schematically illustrates a modified broadcast transport stream;

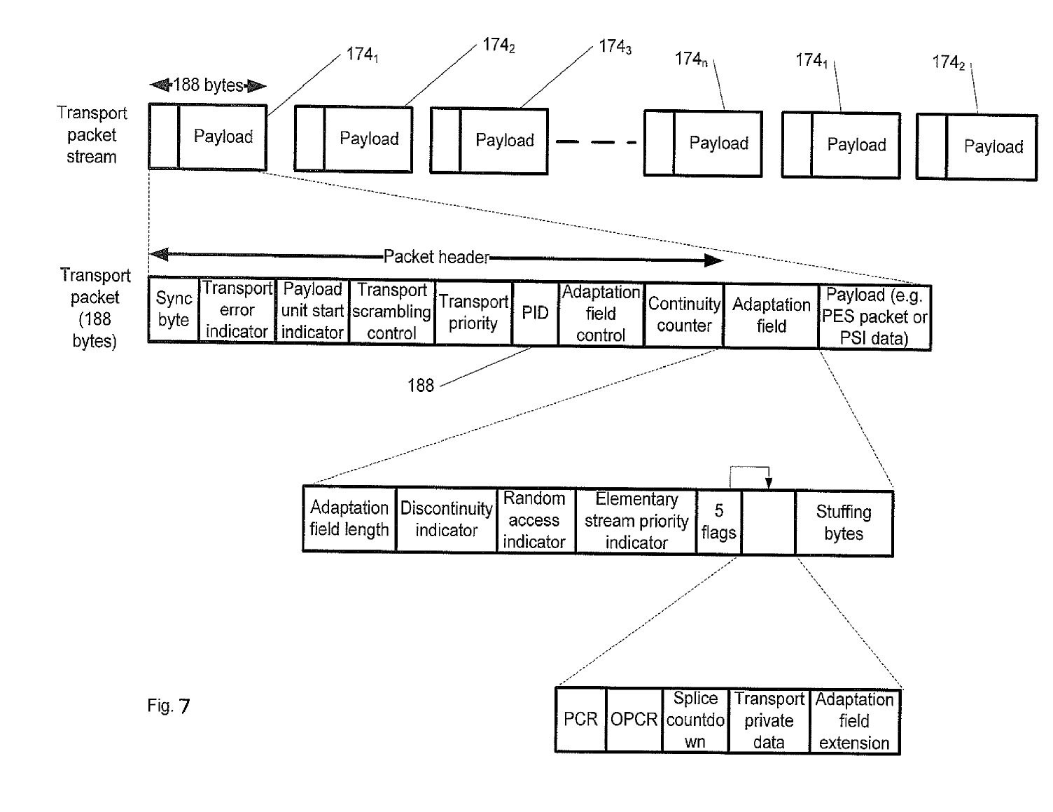

FIG. 7 illustrates, in schematic form, an exploded view an MPEG 2 transport packet stream;

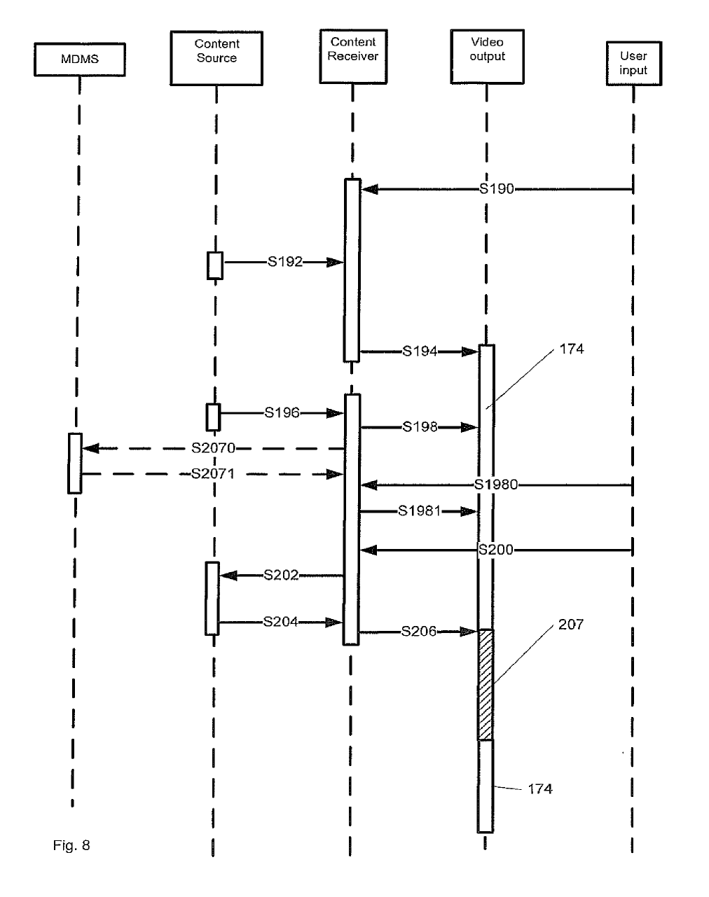

FIG. 8 illustrates a sequence diagram showing steps for display of an alternative content items in place of a broadcast stream received at a content receiver to replace a content item in the stream with a replacement content item; and

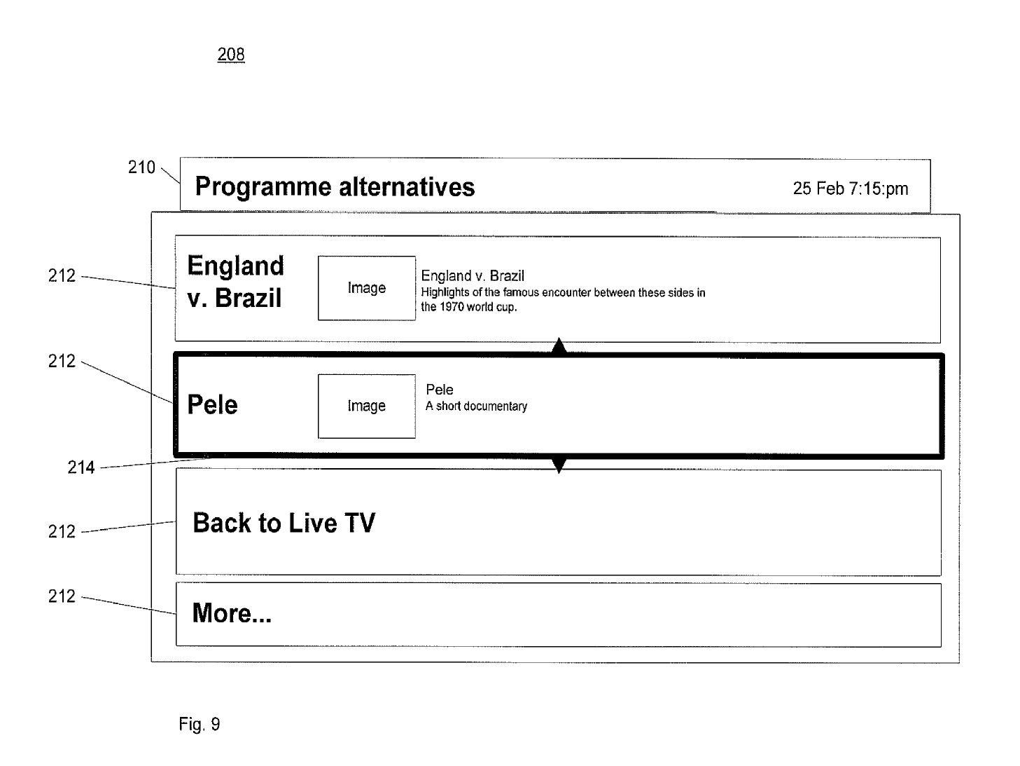

FIG. 9 illustrates a screenshot of a screen displayed when an alternative content item menu is invoked by a content receiver in response to instructions input thereto by a user.

A detailed description of one or more embodiments of the invention follows with reference to the figures provided.

### DETAILED DESCRIPTION OF THE INVENTION

FIG. 1 schematically illustrates components and communication links of a system 100 for providing access from one or more content receivers to content from a plurality of sources. Content may comprise one or more content items, and a content item may be a part or whole of programming content (e.g. a television programme, a film, a video clip, an advertisement, and a system information message).

The system 100 comprises a plurality of content sources 102 arranged to provide content for reception by a plurality of content receivers 108 (e.g. set-top boxes) and subsequent viewing of the content on a display associated with the respective receivers 108 over at least one of a communications network 104 (such as: a wide area network (WAN), e.g. the Internet; local area networks (LAN); or a combination of two or more such networks) and a broadcast video distribution network 106 (e.g. a terrestrial cable IPTV or satellite television broadcast system). The system 100 also comprises a media display management server (MDMS) 110 which controls content configuration and distribution of content to the content receivers 108 and provides a content search and/or discovery and/or navigation module and other services. The MDMS 110 provides a content management environment responsible for the presentation of the content accessed by content receivers 108 (or users thereof) registered with the MDMS 110, giving users a consistent, quality controlled, user interface experience across multiple content types such as broadcast TV, interactive content, and Internet video content.

A media display management module (not shown) is provided in the content receivers 108 for managing the content search, discovery, navigation and presentation on the content receivers 108. The media display management module is configured to communicate with the MDMS 110 over the communications network 104.

The MDMS 110 and the media display management module configure content for display based upon a set of parameters specified by one or more of: a content provider; a user of a content receiver 108; a content receiver 108 manufacturer; and a service provider. The parameters may be embedded as operating parameters of a content receiver 108.

FIG. 2 shematically illustrates the features of FIG. 1 in more detail and provides an overview of the functional elements and modules of the MDMS 110. The features illustrated in FIG. 2 which correspond to features already described in relation to FIG. 1 are denoted by like reference numerals.

In the illustrated embodiment, the MDMS 110 offers a client-server relationship with content receivers 108 comprising TV devices (such as set-top boxes), or as a web service via device Application Programming Interfaces (APIs) to TV devices and other systems. Content receivers 108 comprising TV devices that connect to the MDMS 110 may have embedded in them a content receiver specific client (e.g. media display management module) that enables at least a portion of platform services of the MDMS 110 and content owner and original equipment manufacturer (OEM) branding, i.e. branding for the content receiver, manufacturer or supplier, to be maintained uniformly across device types. Once ported, code changes may not need to be made to the device software to add additional content, features and branding.

For content receivers 108 that connect to the MDMS 10 and which do not have embedded client software, the platform services and content can be enabled via direct services application program interfaces and a TV device user interface. In these instances, a sub-set of the full platform functionality may be used, and content owner and OEM configured branding and services may not be fully-reflected in the interface displayed to the user because of the limitations thereof. However, certain minimal elements may be required to be supported as a condition of utilizing the APIs.

Internet video traffic delivered to TV devices does not pass through the MDMS 110, but utilizes the direct streaming services, protocols, codecs and networking paths from the content owners to the TV devices. While these services, protocols, codecs and the networks utilized are common to Internet video streaming to PCs, TV receivers may only be capable of processing a subset of these protocols and codecs.

Likewise, broadcast content delivered to TV devices does not pass through the MDMS 110 either, but is subject to broadcasting protocols and transmission paths common to broadcast of TV signals to TV devices over suitable media (e.g. Satellite, Antenna, and Cable).

Using the MDMS 110, content owners and media aggregators (i.e. parties who aggregate syndicated web content such as news headlines, weblogs (blogs), podcasts, vlogs (video blogs) in a single proposition) can register and manage their services and content for discovery and use by content receivers 108 configured to receive content made available through the MDMS 110. Content owners can also configure additional products and services via the MDMS 110 such as content subscriptions and promotions and their content owner branding and interactive options are preserved across all devices wherever their content is displayed.

A content receiver user having content stored on their own local content domain may also be able to register and manage content stored on that local content domain using the MDMS 110, and for discovery and use using their content receiver. In this case, the content receiver user is effectively another content owner.

The MDMS 110 implements a range of functions, namely:
a. The registration of Internet video sources and libraries to enable the search, discovery, navigation and playing of content on multiple TV device types;
b. The registration of interactive destinations and TV applications to enable their search, discovery, navigation and access on multiple types of TV device;
c. The management of content branding, media searches, recommendations, interactive links and promotions for content owners (including advertising and sponsorships) such that the correct branding and facilities are displayed to the viewer whenever their content is being accessed, across multiple types of TV device—this capability is common to TV broadcasters, Internet video aggregators, and interactive application owners;
d. The registration of “users”—such as TV viewers, and the management of their personalization information, such that a viewer's identity and personalization information is available across multiple types of TV device;
e. The provision of a range of content discovery services, such as:

i) Centralized search across all content;

ii) Content recommendations;

iii) Content sharing between community members;

iv) Content promotion for content owners;

v) Resolution of TV Keys™
f. The implementation of distribution arrangements and rights restrictions for content owners, particularly the enforcement of territory rights restrictions;
g. Centralized subscription payments services and micro billing (billing for individual content items) for all content owners;
h. Advertising services which may comprise a range of products, for example:

i) “click through” advertising links to video or interactive destinations;

ii) insertion of video advertising in playlists and video content consumption:

iii) interfacing to standard 3.sup.rd party internet ad serving infrastructures and campaign management and sales facilities; and

iv) The provision of viewer targeting data to 3.sup.rd party ad serving engines.

FIG. 3 schematically illustrates the MDMS 110 and components thereof according to one or more embodiments of the present invention.

The MDMS 110 includes a network interface 112 providing a route through which the MDMS 110 is coupled to the communications network 104. The MDMS 110 communicates with the content sources and content receivers over the communications network 104 via the network interface. Content received at the MDMS 110 from the content sources may include, for example, content metadata to feed a search and retrieval module (e.g. Web feeds such as RSS XML feeds), content owner branding data for application to content to be displayed, other content owner rules relating to display and consumption of their content.

A configuration module 114 of the MDMS 110 is configured to provide a means for content owners to register and manage their content. The configuration module 114 comprises a processor and a data storage module.

The configuration module 114 also provides a means by which content receiver manufacturers, i.e. OEM manufacturers, can specify how data and information should be displayed when the system of the invention is implemented using their specific content receivers. An identity services module 124 (described in more detail later) provides a means by which end-users, i.e. viewers using a content receiver implementing the system of the present invention can specify how data and information should be displayed on their content receivers, e.g. personalizing how menus appear when displayed via their content receivers.

A content manager 116 (described in more detail later) is operative to combine these preferences specified by the above three different parties.

When initially registering their content with the MDMS 110 to make such content available to viewers having content receivers configured to receive such content via the MDMS 110, content owners conduct a set-up process using the configuration module 114. This set-up process may be conducted by the content owner, perhaps at a remote location, by way of a content owner terminal, for example, a PC, arranged to communicate with the configuration module 114 via the communications network 104 and network interface 112.

In an example, the content owner could use the PC to navigate to a specific web-page to initiate the set-up process. The configuration module 114, upon receiving a request for the web-page data from the PC, transmits the relevant web-page data to the PC of the content owner to allow the content owner to conduct the set-up process. The content owner is presented with a content owner interface which displays a number of functions relating to how it wishes to configure its content. In this regard, the content owner can define:

It MediaRSS feeds and associated parameters that will be retrieved by the content indexer 118. This is so that the content owner's content items can be presented to a user in search results and recommendations when they are relevant to the search or recommendation being performed by the MDMS 110.

Content item presentation information such as their branding

The categories of content they support e.g. general video, news etc.

Content subscription packages and pricing and the rules used to identify the content items that belong to each subscription package.

Distribution arrangements such as the OEMs or service providers (collectively termed operators) on whose content receivers their content is to be made available and/or in which territories their content can be made available.

The content owner may also wish to configure a content menu application to be made available to the viewer when the viewer is consuming content from that content owner. Again, this content menu registration option may be specified during the initial set-up process or at a later time. The content menu registration option also provides the content owner with the ability to configure specific menu items which access services of the MDMS such as: a search application which allows a viewer to search only within content of that content owner; a content recommendations application which provides a viewer with recommendations from the content of that content owner; quasi-channel applications in which themed content from that content owner is arranged into such quasi-channels either statically or dynamically using pre-defined searches and recommendations which can then be performed without data input from the end viewer; and an advertising application whereby space on the content menu of that content owner can be sold for advertising or can be used to promote specific content from that content owner with the ability to click through the advertising to a piece of content or an interactive destination.

The content owner indicates that the content is configured as they require it to be using the content owner interface of the web-page displayed at their terminal and, upon such indication; the terminal transmits this configuration parameters data via the communications network 104 and network interface 112 to the configuration module 114. Upon receipt of the data, the configuration module 114 sends a confirmation to the content owner terminal that the configuration parameters data has been received and stores the configuration parameters data within its data storage module.

Although described from the viewpoint of a content owner specifying their requirements, a service provider and/or an OEM could specify their own branding and presentation requirements and menus using the same interface, though the options available for configuration may be different for these different roles.

The data storage module of the configuration module 114 is configured to maintain a database of the content configuration parameters data for retrieval by a content manager 116 which can subsequently apply the content configuration parameters data to content to be transmitted to content receivers.

The MDMS 110 is arranged to retrieve the content metadata configured by the content owners to enable the provision of content search and recommendations to content receivers. The content metadata is retrieved over the communications network by the content indexer 118, optionally as a media RSS XML feed. The content indexer 118 retrieves the content owner feed configurations from the content owner configuration 114, retrieving and processing the content owner feeds as specified. The content indexer 118 augments the metadata retrieved from the content owner with derived data using MDMS rules (such as the appropriate MDMS quality classification and the protocols and codecs implied by the one or more content references) and data derived using the relevant content owner configuration retrieved from the content owner configuration 114 (such as the presentation information, distribution networks and territories and the subscription packages that each content item is associated). The XML metadata for each content item is then passed to a search and retrieval module 120 which indexes and stores the content metadata data in its associated storage.

The received content metadata includes data (e.g. a URL) identifying a location at the content source of the actual content instances to which it relates (with each content instance being associated with a different protocol/codec/bandwidth combination) and thus the search and retrieval module 120 maintains a list of content references for each content item registered by content owners.

A search and recommendations module 122 is arranged as an access layer to the search and retrieval module 120. This exposes a straightforward XML based services API to the content manager 116 for each of the service requests the content manager 116 requires and implements each of these requests utilizing one or more of the proprietary APIs and services provided by the search and retrieval module 120.

The MDMS 110 further comprises an identity services module 124 comprising a processor and a user identity storage module. The user identity storage module of the identity services module 124 is configured to store data relating to identities corresponding to different users of a content receiver, e.g. an identity for each individual member of a household. This module provides a user profile data model to be associated with the identities which may comprise:

nickname

personal details including a unique mobile number and/or email address

viewing and content preferences including PIN protection settings

content receivers that this profile is associated with

purchased subscriptions and content items

content item history

content item ratings

content item bookmarks and playlist tags

Various user actions on the content receiver initiate communication with the identity service module 124 some of which result in the current user's profile being updated by the identity services module 124. Examples of these communications include: editing and saving user details and preferences, viewing bookmarks, bookmarking a content item, rating a content item, viewing a content item etc. A default identity of a content receiver may be tied to a unique identifier of the content receiver itself which is used when no individual identity has been identified. This default identity may be associated with the subscriber details where the content receiver has been provisioned by a service provider.

With this arrangement, profile information of users (including, for example, feedback from their consumption of content) can be used to improve targeting and particularly recommendations of content to specific users. This is achieved by the identity services module 124 creating user profiles in the search and retrieval module 120 and populating these with the content items consumed by each user profile. The search and retrieval module can then make consumption informed user recommendations when requested by the search and recommendations module 122.

In response to reception at the MDMS 110 of an instruction from a content receiver to switch user (such instruction invoked by a user action in relation to the content receiver, i.e. selection of a user associated with the content receiver and optionally the entering of a personal identification number (PIN) code, e.g. via a remote control), the instruction, user identifier, receiver identifier and optional PIN are delivered to the identity services module 124 via network interface 112. The identity services module 124 retrieves the relevant user's profile data from its storage module, checks the PIN if required and, if successful, records the new user as the current user for this content receiver in its storage module and generates and returns to the content receiver the user menu appropriate for this user on this content receiver. This new user menu may result in additional requests from the content receiver to the content manager 116 to populate content items (such as the user content recommendations).

When a user of a content receiver wishes to search for specific content and initiates a search via their content receiver to search for such specific content, a search request is received by the network interface 112 via the communications network 104 for the content receiver and delivered to the content manager 116. The content manager 116 then constructs the search query adding a number of additional constraints to the search that are derived from the capabilities and attributes of the content receiver. In particular the content receiver may provide the content receiver identifier, type and operator as part of the search request and the source IP address can be determined from the TCP/IP networking protocols. These are passed to the content receiver profiler 136 which determines and returns:

The protocols and codecs supported by this type of content receiver. This data is configured and stored for each type of content receiver in the content receiver profiler 136. The dataset for this type of content receiver is retrieved from this store.

The operator associated with this content receiver.

The bandwidth capability of this content receiver's network. This bandwidth would have been submitted to the content receiver profiler 136 by the content receiver during an earlier bandwidth test, typically performed on booting the content receiver and stored by the content receiver profiler against the content receiver identifier.

The determined territory of the content receiver. This is derived from the source IP of the content receiver using an IP to geographical location (in this instance, territory) mapping table.

The content manager 116 then instructs the search and recommendations module 122 to execute the constructed search query. The search and recommendations module 122 extracts the search parameter data from the request in order to address the specific interface of the search and retrieval module 120. The search is then performed by the search and retrieval module 120 as instructed by the search and recommendations module 122 and the metadata of the relevant content items is retrieved and returned to the content manager 116. These search results are then transmitted to the content receiver from which the search request was received.

The effect of the combination of this constrained search query implemented by the content manager 116 against the content metadata augmented by the content indexer 118 is to ensure that only content appropriate for and functional on the content receiver is presented to the user. This process applies to recommendations and other content requests.

When a user of a content receiver instigates a search, any content results returned to the user may optionally be tailored for that user based upon the user's profile. Thus, in this case, the content manager 116, upon receipt of a content request via the network interface 112 adds further constraints to the search query. First it requests the user profile data related to the current user who requested the search to the identity services module 124. The identity services module 124 retrieves the user profile data and returns this to the content manager 116. The content manager 116 amends the search request data to include any relevant profile settings (such as safe search i.e. no adult content) as additional terms in the search query prior to submitting the query to the search and recommendations module 122. Upon reception of such amended search request data, the search and recommendations module 122 proceeds in the manner described above to retrieve the metadata of content items relevant to the search request and these search results are returned to the content manager 116. In addition, the content manager 116 may augment the content item metadata returned with relevant user specific metadata such as the user's rating, any user tags, whether or not the user is already entitled to view the content as part of one of their active subscription packages etc. before transmitting the content metadata to the user's content receiver. Thus, a personalized form of content presentation can be delivered to the user while still maintaining the requirements and constraints of other parties (i.e. content owner, etc.).

In some instances a further variation of the above scheme may be utilized, particularly when a user has knowledge of the content items being displayed (such as their bookmarked content items), where content items that are not functional on the device are still returned in the results but have their content item metadata further augmented to indicate that they are non-functional content items. This avoids the user thinking that the system has lost content items that they are aware of if they move between content receivers with different capabilities.

The MDMS 110 offers a range of functions to a user of a content receiver which might include, for example: video search and recommendations; interacting with content provider menus; registering new profiles (individual identities); administering payment instruments and billing, transactions and payments authorization; managing favorites, playlists and history; interacting with messages and other users; and setting up user preferences and options.

A display format for display of the content owner specified and/or personalized form of content on a display screen is delivered to a content receiver from the content manager 116 via network interface 112 and communications network 104. This display format is controlled by the content manager 116 based upon the content configuration parameters data stored in the data storage module of the configuration module 114 and/or the user profile data stored for the current user in the storage module of the identity services 124

The display format is delivered in markup which describes how to display the required functionality of the user interface either via a graphical menu on the TV screen or via a browser application on the content receiver or a third party interactive TV engine.

Communication between the content receiver 108 and MDMS 110 takes place via the content receiver services module 126 which is arranged to service requests from the content receiver 108, enforce security and access controls for protected premium content and may compile XML content responses into a binary representation of XML for efficient communications and processing on the content receiver.

The content receiver services module 126 comprises the following modules: content manager 116 (as hereinbefore described); identity services module 124 (also hereinbefore described); content enforcement module 128; payment services module 130; and image transcoder 132.

The content enforcement module 128 is the element of the content receiver services module 126 configured to gate and authorize the playing of protected (e.g. premium or restricted) content. The content enforcement module 128 operates in conjunction with a payment services module 130, subscription management module 134, the identity services 124 and the content receiver profiler. Such enforcement is implemented by checking territory restrictions, subscription entitlements, informing the user of any gating actions required (e.g. PIN entry required, purchase required, etc.) and requesting authorized content URLs from content owners to provide a content receiver access to a content item. In this regard, a request for a content URL is sent from the content receiver and received at the MDMS 110 via the network interface and forwarded to the content enforcement module 128. The content enforcement module 128 first makes a request to the search and retrieval module 120 for content metadata relating to the content item which the user has requested. The processor of the search and retrieval module 120 retrieves the content metadata from the data storage module of the search and retrieval module 120 and returns the retrieved content metadata to the content enforcement module 128. If the content item is identified as a premium content item the content enforcement module 128 requests the current user's subscription entitlements from the subscription management module 134. The subscription management module 134 retrieves and returns the user's active subscription entitlements to the content enforcement module 128 and the content enforcement module 128 checks these against the content item subscription packages to determine if the user is entitled to view the content item. If the content item is identified as being restricted by territory the content enforcement module 128 requests the content receiver's territory from the content receiver profiler 136 and checks if the content receiver is entitled to access the content item. Finally, the content item is checked to see if it is marked as restricted.

If all conditions are met and the user is eligible to view the content, the URL of the content item is transmitted by the content enforcement module 128, via the network interlace 112, to the content receiver. Upon reception of the content URL the content receiver can then retrieve and play the requested content item from the content owner's content source. Optionally the content enforcement module 128 may request a content access authorization token from the content owner which is transmitted to the content receiver and used by the content receiver when retrieving the content item. This enables the content owner to restrict access to their content to trusted MOMS content receivers.

If, as a result of a determination by the content enforcement module 128, the content requested by a user cannot be viewed by that user then the content enforcement module 128 transmits, via the network interface 112, to the content receiver one of a number of response conditions:

Subscription required with the subscription offers. The offers are presented and if one selected a payment process is initiated by the content receiver against the payment services module 130. On completion of this process the content URL is re-requested from the content enforcement module 128.

PIN required. The PIN is then submitted with a re-request for the content URL which is checked by the identity services module 124 before the content URL is returned.

Unauthorized content. Access to the content is denied.

When a payment process is initiated against the payment services module 130 the content receiver issues a request to the payment services module 130 which returns for payment details to the content receiver. This causes the content receiver to effect display of a payment details request message on an associated display device. In response to the message a user may have the options of rejecting the request for payment details or accepting the request. If the request is accepted, the user is prompted to enter appropriate payment details which are returned to the payment services module 130 via the communications network 104 and network interface 112. As will be appreciated, the user commands in response to the payment details request may be entered via a user interface device, such as a remote control, of the content receiver.

When payment details data is received, confirmed and successfully processed by the payment services module 130, it transfers the subscription purchased to the subscription management module 134 where it is stored against the current user in the associated subscription storage module. The subscription management 134 also forwards this information to the identity services module 124 to update the user profile data relating to that user to include the subscription package upgrade.

Image transcoder 132 is configured to re-encode images stored in standard web formats (e.g. portable network graphics (PNG), JPEG) to a format supported by any given content receiver. Thus, when image data is transmitted to a content receiver, the image transcoder 132 ensures that such images are supported for display by that content receiver. The content receiver informs the image transcoder the source image URL and what image format it requires. The image transcoder 132 retrieves the source image URL over the network interface 112 and then transcodes the image into one of the required formats before transmitting the transcoded image to the content receiver.

FIG. 4 schematically illustrates a content receiver 108, components thereof and components related thereto. The content receiver 108 receives content via the communications network 104 and broadcast video distribution network 106 and can transmit data to the MDMS 110 via communications network 104. Whilst data paths are illustrated between some elements of the content receiver 108, not all data paths are illustrated for the purposes of clarity.

The content receiver 108 comprises a hardware components layer 138, an OS, drivers and middleware layer 139 and a software applications layer 140. Applications in the OS, drivers and middleware layer 139 and software applications layer 140 are arranged to run on a central processing unit (CPU) 141 of the content receiver 108.

Along with CPU 141, the hardware layer 138 comprises a distribution receiver 142, a network interface 146, a demultiplexer 1420, a video decoder 143, an audio processor 1430, a graphics processor 144, a content output module 145, a memory component (RAM) 147, an input receiver 150, and disk storage 163.

The distribution receiver 142 (such as a tuner for receiving a terrestrial digital television broadcast) receives content at the content receiver 108 from the broadcast video distribution network 106 in the form of, e.g. an MPEG 2 transport stream. This transport stream is transferred to demultiplexer 1420 which extracts a data portion of the transport stream and forwards the data portion to the CPU 141 which, in conjunction with an electronic programme guide application (EPG) 148 running thereon, processes EPG data for use by the EPG application.

A video portion of the received content from the broadcast video distribution network 106 is extracted by the demultiplexer and transferred to the video decoder 143. The video decoder 143 prepares video content for output on the content display 149 by the content output module 145. The content output module 145 overlays any graphic output required by any of the software applications identified in the software applications Payer 140 as output by the graphics processor 144 under instruction from the CPU 141 over the video content and outputs the combined output to the content display.

An audio portion of the received content from the broadcast video distribution network 106 is extracted by the demultiplexer and transferred to the audio processor. The audio processor 1430 processes the audio content and outputs to the content display 149.

Output protocols supported by the hardware of the content receiver 108 may comprise one or more of: High Definition Multimedia Interface (HDMI); Component Video; SCART; Composite Video and audio outputs such as Dolby Digital and stereo analogue.

The OS, drivers and middleware layer 139 comprises a graphics layer module 151, a networking services module 152, an audio services module 153, a personal video recorder (PVR) sub-system module 154, a digital video broadcasting (DVB) stack module (155), a storage services module 156, a system services module 157, and an operating system application 161 and drivers 162. These modules are conventional features on many content receivers (such as set-top boxes). Further description of these modules will therefore only be provided where necessary in relation to the functioning of one or more embodiments of the present invention.

Input receiver 150 is arranged to receive commands for controlling the content receiver 108, such commands being input by a user by way of an input device 158. The commands may be entered using, for example, a set-top box remote control device through which commands are entered by the user by pressing specific keys of the remote control device. A control signal from the remote control is transmitted to the content receiver 108 by any suitable means, e.g. infra-red transmission.

The software applications layer 140 of the content receiver 108 comprises: an EPG module 148 (referred to above); a browser application 159; a media display management module application (MDMM) 160; a content determination module 1630; and an alternative content menu compiler 1631.

Although a browser application is shown in the illustrated embodiment, other suitable interactive display engines may be used, e.g. a flash engine such as Adobe® flash engine.

The MDMM 160 runs on the CPU 141 and configures the CPU 141 for communication (via network interface 146) with the MDMS 110 in order to manage content received at the content receiver 108 over the communications network 104. Commands input by a user requesting delivery of a content item to the content receiver 108 are received at the input receiver 150 and communicated to CPU 141 which implements the MDMM 160 to request content data appropriate to the command from the MDMS 110.

Where the CPU 141 instructs the video decoder 143 and audio processor 1430 to process video received over the communications network 104 via the network interface 146 this will be buffered by the CPU 141 in RAM 147 and then the video and audio portions will be retrieved by the video decoder 143 and audio processor 1430 using direct memory access (DMA) in the same manner as when the video was received over the broadcast video distribution network 106 via the distribution receiver 142.

CPU 141 also implements MDMM 160 to manage and control content received at the content receiver 108 over the broadcast video distribution network 106.

Content determination module 1630, executed on CPU 141, monitors content type of a broadcast content item currently displayed by the content receiver 108. The content determination module 1630 determines the content type from meta-data included in the broadcast transport stream received at the content receiver 108. This meta-data may, for example, form part of the EPG data in the transport stream.

Once a determination has been made by the content determination module 1630, a request for alternative content item suggestions is sent via the communications network 104 to the search and retrieval module 120 of MDMS 110. The request includes meta-data indicating the content type currently being viewed and an instruction that alternative content item suggestions relate to the same, or at least similar content type.

The search and retrieval module 120 and other relevant elements of the MDMS 110 performs a search for alternative content items of the same and/or similar type to that being viewed. This search is performed in the same manner as described above in relation to FIG. 3.

Optionally, parameters of the search (i.e. same and/or similar content type to that currently being viewed) may be supplemented with user profile information to further refine the search for a particular user logged-on at the content receiver.

When the search is complete a message for forwarding to the content receiver is prepared by the search and recommendations module 122 of MDMS 110. The message includes meta-date indicating, for example, title information for one or more alternative content items found during the search and locators (e.g. URLs) for each of those one or more alternative content items. The locators are pointers to addresses at content providers' repositories where the alternative content items are stored. The message is forwarded to the content receiver 108 via communications network and is received thereat by network interface 146.

The alternative content menu compiler 1631, executed on CPU 141, extracts the meta-data from the message received at the content receiver and includes such meta-data in alternative content item identifier fields in an alternative content item menu.

The alternative content item menu comprises one or more alternative content item identifier fields, with each alternative content item identifier field relating to a particular alternative content item.

Alternative content item menu data is forwarded to the RAM 147 for retrieval by the graphics processor 144 at a later time for display. The alternative content item menu may be invoked for display by the content receiver upon receipt of an instruction input by a user. Upon receipt of such an instruction, the alternative content item menu data is retrieved from RAM 147 and rendered for display by the graphics processor 144.

In one or more embodiments of the present invention, one or more alternative content items and/or an alternative content item menu is only available for display when a transition point occurs in a broadcast content item received at the content receiver 108. The transition point denotes a change in content type from a primary type to a second type and will be described in more detail later.

The instruction input by a user may be entered voluntarily or in response to a prompt displayed via the content receiver at the start of a break in content type (described further below).

A single broadcast content item will often include one or more transition points defining start and end-points of breaks in content where the content type changes. Thus, if the single broadcast content item is thought of as a “primary” broadcast content item and the content therein a “primary” content type, one or more other content items in the one or more breaks may be thought of as “secondary” broadcast content items containing content of a “secondary” or other content type.

While the breaks in content may correspond to an advertisement break in the primary broadcast content item, i.e. the primary broadcast content item is a TV programme and the second broadcast content items are advertisement breaks, this need not be the case.

For instance, in a live televised football match, the first and second halves (i.e. live play) are one type of content, whilst the analysis section at half-time is a different type of content.

A viewer may not be interested in the half-time analysis and may choose to view-something else. A broadcaster, however, will wish to retain the viewer's attention (to maintain viewing figures) and so can offer alternatives, e.g. recommended content which the viewer can watch during this period and which originates from the broadcaster.

In the football match example provided above, the content determination module 1630 determines (from EPG data) that the content type currently being viewed is, generally, “Sport” and, more particularly, “Football”. Upon such determination being made, a request for alternative content items is sent to search and retrieval module 120 of the MDMS 110.

The search and retrieval module 120 conducts a search using these parameters (perhaps supplemented based upon user profile). Upon completion of the search, the search and recommendations module 122 forwards a message to the content receiver 108 containing information (e.g. URLs) to allow the content receiver 108, if so instructed, to access one or more alternative content items found in the search.

In the present example, the search might only contain alternative content items relating to football (since this is the type of content currently being viewed), and these items will only be the property of the broadcaster whose content is currently being viewed. Once the first half of the live match ends, the content receiver, upon instruction from the user, invokes display of the alternative content item menu containing a list of one or more alternative content item identifiers. Each alternative content item identifier relates to an item of content of a football-related type. The user selects a particular alternative content item identifier by entering an instruction to the content receiver 108, and the content receiver 108, in response thereto, sends a request to the broadcasters content repository for retrieval of the selected alternative content item.

The broadcaster's system locates and retrieves the alternative content item the repository and returns the item to the content receiver 108 via communications network 104. The received alternative content item is then displayed via content receiver 108.

An arrangement by which a change in content type from a primary content type to a secondary content type is indicated to the content receiver 108 will be described later.

DVB stack 155 comprises a series of modules operative to drive the TV system of the content receiver. Such a feature is known in conventional content receivers (e.g. set-top boxes) and known manufacturers are, for example, OpenTV, NDS, or Direct TV.

The DVB stack 155 is configured to detect a signal in a received broadcast video content item indicating the start point of the break. The DVB stack 155 forwards a second notification signal to the CPU 141 that such a signal has been detected. Upon receipt of such second notification signal at the CPU 141, the CPU 141 instructs the graphics processor 144 to invoke display of the alternative content item menu. The graphics processor 144 performs direct memory access (DMA) from RAM 147 to retrieve the alternative content item menu data. Upon retrieval, the graphics processor 144 invokes display on content display 149 via content output 145.

It is generally envisaged that a total duration of all the one or more alternative content items is at least equal to the length of the break in the primary content item. That is, each of the alternative content items found in the search is approximately the duration of the break. However, the combined duration of all alternative content items found in the search could be the same length as the break. In this case, a user could view all alternative content items during the break in the primary content item and return to viewing the primary content item for its resumption after the break to view the primary content item live. However, if, through delays in selection of an alternative content item and/or user entered commands during the break, to watch an alternative content item to its conclusion would cause overlap with resumption of the primary content item, the content receiver invokes display of a prompt which allows the user to select to continue watching the alternative content item to its conclusion or to return to the live primary content item.

In order to indicate to the content receiver that a change of content type of a broadcast video content stream received at the content receiver changes from a primary content type to a secondary content type (i.e. a break in the primary content item), markers denoting the start and end of the break in the primary content item are required. These markers are required in the transport stream (such as an MPEG 2 transport stream) of the broadcast video content stream. A start marker indicates to the content receiver a change in the content type of the broadcast video content stream from primary-type content to secondary-type content, i.e. at the start of the break in the primary content item. An end marker indicates the end of the break in the primary content item, i.e. a transition from secondary-type content to primary-type content.

These markers will be discussed in more detail below in relation to FIG. 6.

A typical video content broadcast stream, as illustrated in FIG. 5, such as a live television (satellite, terrestrial or cable) broadcast, contains a primary broadcast video content item 174 and one or more breaks 176 in the primary broadcast video content item 174. A typical video content broadcast stream may comprise an MPEG 2 transport stream. The MPEG 2 transport stream is described in more detail in relation to FIG. 7.

Each of the one or more breaks 176 comprises a specified time window in which at least one secondary (or alternative) video content item is displayed.

In the particular example described above, the primary video content item 174 comprises a television programme (i.e. a televised football match) and a single “half-time” break 176 between the two halves of the football match. During this break, one or more secondary broadcast video content items, (e.g. an analysis section and/or advertisement content items) are displayed. In the figure, the break comprises: a first section 176a containing one or more advertisement content items; a second section 176b containing an analysis section; and a third section 176c containing one or more advertisement content items.

Transition from the primary broadcast video content item 174 to the break 176 occurs at a first transition point 178, whilst transition from the break 176 back to the primary broadcast video content item 174 occurs at second transition point 180.

While FIG. 5 schematically illustrates a conventional broadcast video stream, FIG. 6 illustrates a modified broadcast video stream modified by a content source provider (i.e. a broadcaster) to include markers for indicating: the start of a break in the primary content item; and the end of the break in the primary content item.

Thus, whilst the primary broadcast video content item 174 and the break 176 in the primary content item are the same as illustrated and described in relation to FIG. 5, the broadcast video stream also includes a start marker 182, and an end marker 184. The start marker 182 indicates the start of the break in the primary content item, and the end marker 184 indicates the conclusion of the break in the primary content item.

FIG. 7 illustrates, schematic form, an exploded view of an MPEG 2 transport packet stream.

MPEG 2 transport packet streams are known and further description of the conventional aspects thereof will not be provided here.

A packet header of an MPEG 2 transport packet includes a program identifier (PID) 188. A program map table (PMT) contains information about programs and is transmitted via the PID 188. In one or more embodiments of the present invention, a conventional PMT is modified to include a break-in-primary-content-item table-entry. The break-in-primary-content-item table entry comprises a private section of the PMT and includes the following: a start presentation time stamp (PTS) for a packetized elementary stream (PES) packet that contains a start point of the break in the primary content item; an end PTS for the PES packet that contains a start point of a programme that is about to start/resume, i.e. an end point of the break in the primary content item. These start PTS and end PTS correspond to the start marker 182 and end marker 184 of FIG. 6.

The break-in-primary-content-item table also includes data indicating the duration of the secondary content item segment. This data can be used to determine suitable alternative content items having an appropriate length for the break in the primary content item.

Additionally, or alternatively, the duration of the secondary content item segment could be detailed as part of EPG data provided by the broadcaster with the table including data that identifies the associated EPG content segment.

Further, a broadcast signal may include data containing tail the alternative content items available for display and/or references (IDs) of the alternative content items available for display. Details of the alternative content items available for display (e.g. addresses where the alternative content items are stored) can be retrieved by the content receiver from the MDMS using the references.

The end PTS for the PES packet that contains a start point of a programme that is about to start/resume after a break in the primary content item provides a notification to the video decoder of the content receiver to cease display of the displayed alternative content item and resume the primary broadcast video content item, i.e. a TV programme. However, in an optional arrangement, to be described in further detail below, this end PTS may be ignored to allow the alternative content item to be viewed in full. In this case, the TV programme is recorded to disk storage of the content receiver (if the content receiver, i.e. STB, comprises a PVR) and is resumed when the alternative content item has completed.

The break-in-primary-content-item table entry optionally includes a pre-start PTS for the PES packet that contains a portion of a programme that is about to transfer to a break in the primary content item. For example, the portion of the program may be between 0.5 and 5 seconds.

FIG. 8 illustrates a sequence diagram showing steps for display of alternative content items during a segment of programming sequencing when alternative content to the broadcast stream is available.

If, after the display of an alternative content item, the time remaining in the break in the primary content item is such that no meaningful portion of another alternative content item can be displayed, then the content receiver returns viewing to the secondary content item in the broadcast content stream.

The description relating to FIG. 8 is made with reference to FIGS. 3, 4, and 6 to 8.

A user input “View TV” instruction (S190) received at the content receiver instructs the content receiver to tune to a TV channel indicated in the instruction, and the content receiver tunes to such a TV channel (S192). A broadcast video content item 174 broadcast on such TV channel is displayed (S194).

When a start marker is received (S196) at the content receiver, the content receiver invokes display (S198) of a prompt indicating that an alternative content item menu is available to be invoked for display. The alternative content items menu is displayed when the user inputs instructions to the content receiver to invoke display of said menu (S1980).

In the illustrated example, display of the prompt is automatic once the start marker is received at the content receiver. However, in an optional arrangement, the prompt is not displayed but upon a user instruction (S1980) received at the content receiver to invoke such display the alternative content items menu is displayed (S1981).

In the present example, a user input “Select alternative content item” instruction (S200) received at the content receiver instructs the content receiver to send a request (S202) to a content source at which the selected alternative content item is displayed.

The selected alternative content item is retrieved from a repository at the content source and returned (S204) to the content receiver. Upon receipt of the selected alternative content item, the content receiver displays the alternative content item 207 (S206).

During display of the selected alternative content item 207 the content receiver is free to receive user instructions to invoke display of the alternative content items menu. Further alternative content items can be selected for display either in place of the originally selected alternative content item or once the originally selected alternative content item has concluded.

Dashed arrows (S2070 and S2071) indicate additional steps for display of alternative content items in an optional arrangement.

In such an optional arrangement, details of the alternative content items are not provided in a broadcast signal or in EPG data. The details may comprise, for example, meta-data relating to the alternative content items themselves (to populate information fields in said menu) and/or addresses where the alternative content items are stored. In this optional arrangement, because alternative content item data is not available to the content receiver via the broadcast signal /EPG data, the content receiver sends a request (S2070) for available alternative content items via communication network to the MDMS. The MDMS receives the request and compiles a data set for each available alternative content item. The data set is returned (S2071) to the content receiver which then populates the menu using the received data.

In a further optional arrangement, the request, sent (S2070) by the content receiver for available alternative content items via communication network to the MDMS, may be based upon personalized matching criteria (i.e. a request to find alternatives based upon preferences indicated in a user profile), or may be based upon search criteria input by a user.

Whilst it may be necessary to truncate the display of an alternative content item in order to return viewing to a primary content item, this need not be the case.

In a content receiver which has a programme recording capability, rather than returning to the display of a television programme, a final, or only, alternative content item may be displayed in full before returning to display of the television programme. The recording facility of the content receiver is arranged to record the television programme from the end of the break in the primary content item until instructed to stop recording. Thus, when the final, or only, alternative content item concludes, it is not the live television programme which is displayed, but a recorded version of it.

When the final, or only alternative content item is viewed in full, the content receiver may also offer the user the option of viewing the television programme from its current live point, i.e. an initial portion of the television programme overlapping with the final, or only, alternative content item after the end of the break in the primary content item will be missed, or to watch a recorded version of the television programme as described above.

Optionally, when one or more alternative content items are displayed during a break in the primary content item, upon resumption of the primary content item, the content receiver automatically stops playing an alternative content item currently being displayed and displays the primary content item.

In one or more embodiments of the present invention, the content receiver is configured to invoke display of a menu listing alternative content items available for insertion in a primary broadcast video content item between a pair of transition points in the primary broadcast video content item. Such display may be invoked upon receipt at the content receiver of a command requesting such display from a user input device or may be displayed automatically after a first transition point occurs in the primary broadcast video content item.

In such a case the content receiver is configured to present a viewer with the option of watching alternative content, for example, recommended content, at a transition point in a primary broadcast video content item.

The transition point may be a point in the primary broadcast video content item where the type of content changes. In the example described above, i.e. in a live televised football match, the first and second halves (i.e. live play) are one type of content, whilst the analysis section at half-time is a different type of content.

The viewer may not be interested in the half-time analysis and may choose to view something else. The broadcaster, however, wishes to retain the viewer's attention and so can offer alternative, e.g. recommended, content which the viewer can watch during this period and which originates from the broadcaster. This recommended content may either be “pushed” by the broadcaster or “pulled” by the user, typically from the broadcaster's portal.

The viewer can instruct the content receiver to invoke the display of a menu indicating the broadcaster's recommended content.

The content available will typically be of a length so that it can be viewed in full whilst still allowing the viewer to return to the original content at, for example, the second-half.

Available alternative content items may comprise one or more of:

specific broadcaster specified alternatives (as mentioned above). Locators indicating addresses where the content items can be retrieved and metadata comprising, for example, content title, synopsis, image data relating to each content item may be provided to the content receiver either in the broadcast signal stream or returned by an online transaction, or as part of extended EPG data (which may be made available online or over broadcast);

alternative content items returned by an MDMS request for relevant content by the same broadcaster or recommendations by the broadcaster of other content; and

alternative content items returned by an MDMS request for relevant content available from any broadcaster/broadband content provider.

The extended EPG data can be used by the MDMS 110 to determine a content type, so that appropriate recommendations can be forwarded to a content receiver, i.e. if a user is watching a primary content item which comprises sporting content, then the MDMS 110 determines the currently viewed content type, locates alternative content items matching this type, and recommends (or will present in response to a search invoked by the user) sports-related alternative content items.

Similarly, extended EPG data can be used by the MDMS 110 to determine content type. The MDMS 110 can use results of this determination to match alternative content items to a user profile. Appropriate alternative content items can be recommended (or presented in response to a search invoked by the user) based upon the user profile.

FIG. 9 illustrates a screenshot 208 of a screen displayed when such a menu feature is invoked by a user. The menu comprises a list of alternative content identifier items comprising links to alternative content items. The list of alternative content identifier items can be optionally stored in disk storage 163 of the content receiver 108.

The menu contains a title field 210, a list of content identifier items 212, and a cursor 214.

The title (in this case “Programme alternatives”) is displayed in the title field 210.

The list of content identifier items 212 comprises a vertical list of identifier items relating to alternative content items stored at one or more content sources. Each content identifier item 212 includes a link (e.g. URL) to allow the content receiver to retrieve the content item from the content source if selected. The content identifier items 212 provide at least a name of the alternative content item (e.g. Title). Thus, if a user selects a particular content identifier item, the alternative content item associated with that identifier will be retrieved and displayed using processes as described above.

Cursor 214 comprises a movable indication feature which highlights one content identifier item in the list of content identifier items 212. The cursor is movable vertically from a first position where a first content identifier item is highlighted to a second adjacent position where a second content identifier item is highlighted responsive to user input via the input device (e.g. Up/Down keys of a remote control).

When the cursor 214 is located over a content identifier item 212, the highlighted item may be enlarged (compared with other content identifier items in the list of content identifier items 212) and/or gain a border. Additionally, further information relating to the content may be displayed within the content identifier item 212 (e.g. Quality (HD/SD), Premium Icon (to indicate that payment is required to view the content), age certificate icon, a content owner logo, content length, and one-line synopsis of content).

The content identifier items 212 may comprise one or more of: image data; video data; and text data. The image data may comprise images and/or icons in a particular format e.g. JPEG.

The cursor 214 may also comprise a directional indicator to indicate to a user that the list can be navigated using Up/Down arrows of the remote control. If the cursor is positioned over the first item in the list only a down indicator should be visible and, likewise, if the cursor is positioned over the last item in the list, only an up indicator should be visible.

However, in an optional arrangement, the list of content identifier items 212 may be arranged in a carousel manner such that there is no beginning and no end. In such an arrangement, both the up and down indicators are always visible.

In the illustrative example of FIG. 9, when a first transition point occurs in a live broadcast video content item, and the content type changes, the display of the menu may then be invoked upon receipt of a command entered into the input device by the user, or may be invoked automatically.

If, for instance, the primary broadcast video content item is a television programme comprising a football match between, e.g. England and Brazil, the alternative content items displayed in the menu will be related in some way to either, or both, teams, current or previous players, or some other content of a sporting nature. This is an optional arrangement, however, and the alternative content items may be any content items which are likely to be of interest to the viewer currently logged on to the content receiver. Whether or not a content item is likely to be of interest to a viewer is based upon their user profile. The menu also contains an option to continue, or return to watching the live television programme.

The user may select from the menu a desired alternative content item for display.

The length of the break between two halves in a football match is typically fifteen minutes and this break in the live broadcast video content item is maintained so that the viewer is returned to the live broadcast video content at the end of the break, i.e. when the second transition point occurs, the live broadcast video content item is resumed. This may entail truncating a final alternative content item being viewed before resumption of the live broadcast video content. For example, if a viewer begins watching a five-minute alternative video content item four minutes before the content is due to resume, the final one minute of the alternative video content item will not be displayed.

In an optional arrangement, the viewer may opt to view the entirety of the final alternative video content item and return to the primary content item, i.e. the televised football match, either at the live point or at a point in history (this second option would only be available where the content receiver comprises a programme recording function). Thus, if the alternative content item will overrun the re-commencement of the live content, the system will present a reminder to the viewer that the original content is about to resume. The user may have the option of returning to the original content or watching the recommended content to its conclusion and re-joining the original content at either the live point or at a point in history.

In an additional and/or alternative arrangement, alternative content items can be presented to a user for viewing in place of a primary content item. Thus, the user could instruct the above noted system to present recommendations of alternative content items and/or invoke a search for alternative content items, with one or ore of such alternative content items being viewed in place of the primary content item.

Such alternative content items may comprise any content items of a broadcaster, a channel of which the content receiver is currently displaying. The alternative content items may be more specific, e.g. if a match/game in a sporting tournament is currently being displayed, the alternatives may be other matches/games in the same tournament.

In a modification of the above arrangement, the content receiver will display a selected alternative content item in place of a primary content item until the next primary content item commences.

Alternative content items available from a particular broadcaster can be presented to the user via display invoked by the content receiver in response to a user input instruction to invoke display of the alternative content items themselves (or a list thereof) or automatically when the content receiver is tuned to a channel of that broadcaster.

The above one or more embodiments are to be understood as illustrative examples of the invention. Further embodiments of the invention are envisaged as follows.

In an optional arrangement, replacement advertisement content items may be inserted into breaks in the broadcast content item other than advertisement breaks. For example, if transmission of the broadcast content item fails and thus no broadcast signal is received at the content receiver, replacement advertisement content items could automatically be displayed.

In one or more embodiments of the invention, a replacement advertisement database may comprise a protected portion of disk storage 163. Only replacement advertisement content items may be stored in this portion of disk storage 163.

In one or more embodiments of the invention content distribution is via transmission over both a communications network (as either streaming video or as a progressive download) and a video distribution network (as broadcast video). The communications network may be for example the Internet or a local private network, a wireless network, or a telecommunications network such as for example General Packet Radio Service (GPRS) or a telecommunications network based on a Third Generation (3G) telecommunications standard such as for example the Universal Mobile Telecommunications System (UMTS) or Code Division Multiple Access 2000 (CDMA2000) and the distribution receiver receives the transmission via a communications network, for example a network card, or a broadband modem, or a wireless network card, or a telecommunications receiver such as a GPRS receiver or a receiver based on a Third Generation (3G) telecommunications standard such as for example the Universal Mobile Telecommunications System (UTMS) or Code Division Multiple Access 2000 (CDMA2000).

In one or more embodiments of the invention content distribution technique may be via a storage medium for example a hard disc, or an optical storage medium such as a Digital Versatile Disc (DVD) or a High Definition DVD (HD-DVD) such as a Blue Ray Disc, and the content receiver is a device for accessing the storage medium, such as a hard disc or a DVD player or an HD-DVD player.

In one or more embodiments of the invention content distribution may be via a user-recorded storage medium, such as a hard disc or a Video Home System (VHS) cassette or for example an optical storage medium such as a Digital Versatile Disc (DVD) or a High Definition DVD (HD-DVD) such as a Blue Ray Disc, and the content receiver is a device for accessing the user recorded storage medium, such as means for accessing a hard disc or a VHS cassette player or a DVD player or an HD-DVD player.

In one or more embodiments of the invention content distribution nay be via a user-recorded storage medium that is internal to the content receiver.

In one or more embodiments of the invention content distribution may be via a user-recorded storage medium that is external to and coupled with the content receiver.

In one or more embodiments of the invention content distribution may be via a user-recorded storage medium at a remote location and includes transmission to the content receiver via a communications network such as for example the Internet.

In one or more embodiments of the invention content distribution distribution may be via an analogue broadcast.

In one or more embodiments of the invention content distribution may be via a digital broadcast.

In one or more embodiments of the invention content distribution may be via terrestrial television broadcast and the content receiver is a terrestrial television receiver.

In one or more embodiments of the invention content distribution may be via satellite television broadcast and the content receiver is a satellite television receiver.

In one or more embodiments of the invention content distribution may be via cable television broadcast and the content receiver is a cable television receiver.

In one or more embodiments of the invention, the content receiver may be configured to specify its capabilities to the MDMS, for example, each time search request is invoked, and/or when a request for content is sent to the MDMS.

In one or more embodiments of the invention the content receiver may be a computer, or content stored on a computer on a home network.

In one or more embodiments of the invention the content receiver may be a mobile device such as for example a portable computer, a mobile phone or another receiver of Digital Video Broadcast for Handheld devices (DVB-H).

In one or more embodiments of the invention the content display may be a visual display unit such as a computer monitor.

In one or more embodiments of the invention the content display may be a screen embedded in a mobile device.

In one or more embodiments of he invention the content navigation module may be invoked via the user selection of a menu item displayed by the video receiver.

In one or more embodiments of the invention the content navigation module and the browser application may be components of a single computer program.

In one or more embodiments of the invention the content navigation module may be implemented as dynamically generated content presented by the content receiver, for example where the dynamically generated content is a web page in a markup language such as for example Hypertext Markup Language (HTML).

In one or more embodiments of the invention the content navigation module may be implemented as dynamically generated content presented by the browser application that is generated by a remote system and transmitted to the browser application via a communications network.

In one or more embodiments of the invention the content receiver may be able to render items of content relating to TV applications described in a markup language or other Interactive engine such as for example Hypertext Markup Language (HTML), TV Markup Language (TVML, or wTVML), Extensible HTML (XHTML), XHTML Basic, CE-HTML or another Extensible Markup Language (XML) based content description.

In one or more embodiments of the invention, the browser application may be able to render content in the form of a video sequence such as for example a video received via a communications network or a video distributed via a broadcast method received by the content receiver or a video stored on a storage medium accessed by the content receiver.

In one or more embodiments of the invention the search function comprises a sub-image embedded in content.

In one or more embodiments of the invention the input device may be a keypad on a mobile device, for example a keypad on a mobile phone.

In one or more embodiments of the invention the link to content may be a Universal Resource Identifier (URI).

In one or more embodiments of the invention the link to content may direct the content receiver to access content that is for example a video sequence that is for example received via a communications network or distributed via a broadcast method or stored on a storage medium, or a TV application capable of being accessed via an interactive content engine installed on the device.

In one or more embodiments of the invention, the links to content may be paid-for interactive or video advertisements.

In one or more embodiments of the invention the content output component may be able to present a video sequence decoded by the video decoder in one portion of the video display and graphics produced by programs running on the graphics processor in another portion of the display.

In one or more embodiments of the invention, the content output component may be able to present graphics produced by programs running on the graphics processor that consume the entire display.

In one or more embodiments of the invention, the content output component produces an analogue computer display signal such as a Video Graphics Array (VGA) signal.

In one or more embodiments of the invention, the video output component produces a digital display signal such as a Digital Visual Interface (DVI) signal.

In one or more embodiments of the invention, the video output component produces a high-definition digital display signal such as a High-Definition Multimedia Interface (HDMI) signal.

It will be appreciated that the term “playback” is intended to refer to the display of live video content such as a live sporting event as well as recorded video content.

It is to be understood that any feature described in relation to any one embodiment may be used alone, or in combination with other features described, and may also be used in combination with one or more features of any other of the embodiments, or any combination of any other of the embodiments.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writeable or re-writeable media, digital or analogue media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carder media are also envisaged as aspects of the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

The scope of the present disclosure includes any novel feature or combination of features disclosed therein either explicitly or implicitly or any generalization thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

What is claimed is:

1. A method of operating data processing apparatus for content item delivery and display that has a CPU and a software program, the method comprising the steps of:
determining a change in a content type in an original broadcast stream of content items being delivered to a content item receiver apparatus for display on a display apparatus; and
initiating a display of one or more alternative content items having identifiers on the display apparatus, wherein the one or more alternative content items are derived from a computed selection of alternative content items delivered via a broadband connection, such that the display initiation occurs without user intervention and the one or more alternative content items have a similar duration as a duration of the change in the content type of the original broadcast stream.

2. The method according to claim 1, further comprising:
searching over a broadband communications network for the one or more alternative content items.

3. The method according to claim 2, further comprising:
searching for the one or more alternative content items amongst data identifying one or more alternative content items and content type currently broadcast on channels of a broadcast communications network.

4. The method according to claim 3, further comprising:
searching for the one or more alternative content items from amongst data identifying one or more alternative content items and content type controlled by a same entity controlling the original broadcast stream.

5. The method according to claim 1, further comprising:
determining a return to the original broadcast stream based on information concerning a duration of a change content type of the original broadcast stream.

6. The method according to claim 5, further comprising:
initiating automatic return to delivery and display of the original broadcast stream responsive to determining the return to the content type of the original broadcast stream.

7. The method according to claim 5, further comprising:
initiating display of a viewer message on the display apparatus providing a user actuatable option to return to the original broadcast stream or continue with the display of the one or more alternative content items.

8. The method according to claim 1, further comprising:
determining a content type of the original broadcast stream.

9. The method according to claim 7, further comprising:
identifying the one or more alternative content items having content of a similar type to the content type of the original broadcast stream.

10. The method according to claim 9, further comprising:
searched dynamically content providers for the one or more alternative content items.

11. A method of operating data processing apparatus for content item delivery and display that has a CPU and a software program, the method comprising:
determining a change in a content type in an original broadcast stream of content items being delivered to a content item receiver apparatus for display on a display apparatus; and
initiating a display of one or more alternative content items having identifiers on the display apparatus based upon a user selection of a one of said one or more content item identifiers, with an ability to return to the original broadcast stream, wherein the one or more alternative content items are derived from a selection of alternative content items delivered via a broadband connection.

12. The method according to claim 11, further comprising:
searching over a broadband communications network for the one or more alternative content items.

13. The method according to claim 12, further comprising:
searching for the one or more alternative content items amongst data identifying one or more alternative content items and content type currently broadcast on channels of a broadcast communications network.

14. The method according to claim 13, further comprising:
searching for the one or more alternative content items from amongst data identifying one or more alternative content items and content type controlled by a same entity controlling the original broadcast stream.

15. The method according to claim 11, further comprising:
determining a return to the original broadcast stream based on information concerning a duration of a change of content type of the original broadcast stream.

16. The method according to claim 15, further comprising:
initiating automatic return to delivery and display of the original broadcast stream responsive to determining the return to the content type of the original broadcast stream.

17. The method according to claim 15, further comprising:
initiating display of a viewer message on the display apparatus providing a user actuatable option to return to the original broadcast stream or continue with the display of the one or more alternative content items.

18. The method according to claim 11, further comprising:
determining a content type of the original broadcast stream.

19. The method according to claim 17, further comprising:
identifying the one or more alternative content items having content of a similar type to the content type of the original broadcast stream.

20. The method according to claim 17, further comprising:
searched dynamically content providers for the one or more alternative content items.
